(19) United States
(12) Patent Application Publication
(10) Pub. No.: US 2017/0029922 A1
(43) Pub. Date: Feb. 2, 2017

(54) ENVIRONMENTALLY FRIENDLY TREATMENT METHOD OF REFINING MAGNESIUM SLAG

(71) Applicants: Heyi Tan, Xiangtan (CN); Lunyuan Tang, Xiangtan (CN)

(72) Inventors: Heyi TAN, Xiangtan (CN); Lunyuan TANG, Xiangtan (CN)

(21) Appl. No.: 15/293,281

(22) Filed: Oct. 14, 2016

Related U.S. Application Data
(63) Continuation of application No. PCT/CN2014/075237, filed on Apr. 14, 2014.

(51) Int. Cl. C22B 26/22; C22B 7/00; C01F 5/04; C22B 7/04

(52) U.S. Cl. CPC C22B 26/22; C22B 7/04; C22B 7/006; C22B 7/005; C01F 5/04

(57) ABSTRACT

A treatment method for a magnesium slag, comprises: Step a, producing magnesium particles and a crude solution of magnesium slag by digesting and sifting a magnesium slag; Step b, filtering the crude solution of magnesium slag sifted in Step a, so that mixed chlorides are obtained after a moisture in a filtrate is removed; Step c, obtaining a high purity magnesium oxide by dissolving a filter residue obtained in Step b via an ammonium sulfate method and a magnesium precipitation reaction as well as post-treatment. With the method, utilization of magnesium slag can reach up to more than 90% with a higher recycling rate, while the discharge of solid wastes can be reduced greatly which solid wastes are less contaminative to the environment, so that the contamination to the environment is greatly reduced and the required energy saving and emission reduction are also achieved.

### CROSS REFERENCE TO RELATED APPLICATIONS

This application is a continuation of PCT/CN2014/075237 filed Apr. 14, 2014, which is incorporated herein by reference.

### TECHNICAL FIELD

The present invention relates to a recycling treatment method for industrial wastes, and in particular a treatment method for a refined magnesium slag, particularly a treatment method for a refined magnesium slag.

### BACKGROUND

With drastically raising consumption of metal materials, the earth's crust resources are depleted gradually, including many traditional metal minerals which are tending to run out, so that accelerated development of magnesium metal materials is one of the important measures for a sustainably developing society. Magnesium metal can be used to produce high strength alloys with other metals like aluminum, copper or zinc due to its low density. Further, magnesium and its alloys are becoming first choice for materials used in industries such as modern automobiles and telecommunication because the magnesium alloy has a low density, perfect thermal and electrical conductivities, good shock damping and electromagnetic shielding functions and is easy to fabricate and waste recycle, so that they are honored as green engineering material in Twenty First century. However, with an annually increasing consumer demand for magnesium metal around the world, some countries and regions even reserve magnesium metal as strategic materials. In addition, a plurality of enterprises for producing primary magnesium at home and abroad have been shut down due to environmental and cost problems, thereby causing huge impact on the world magnesium industry setup. Based on data statistics from the United States Geological Survey (USGS), the world magnesium yield in 2011 amounts to seven hundred and seventy one thousand tons, among which the magnesium yield in China reaches six hundred and sixty one thousand tons, taking up about 85.7% of the whole world. And although it had been affected by the international financial crisis impact, the yield of primary magnesium in China decreases and amounts to six hundred and forty thousand tons, taking up about 85.3% of the whole world in 2012 which is a relatively tough year for running conditions in the magnesium industry in China.

However, the magnesium metal industry brings about a series of environmental problems during in the process of high speed development in our country. The refined magnesium slag is a waste produced in the refining process of magnesium, magnesium alloy and waste materials thereof, wherein 100 to 300 Kg of industrial wastes are generated per ton of refined magnesium, magnesium alloy and waste materials. In our country, the industrial slag discharged during refining process of magnesium metal and magnesium alloy is discarded as waste in many magnesium plants. In particular, a huge amount of magnesium slag are discharged and accumulated in some small manufacturing enterprises which not only occupy a lot of land resources, but also impact greatly on the crops and surrounding environment with the magnesium slag being entered into the river and lake along with a flushing rain, thereby severely impairing fitness and health of humankind and growth of crops. At present time, the annual magnesium yield of the whole world reaches about seven hundred and fifty thousand tons, among which the magnesium yield of our country is on top of the list with six hundred and forty thousand tons, while the magnesium slag produced by refining magnesium, magnesium alloy and their wastes amounts to more than one hundred thousand tons.

Magnesium enterprises in our country are generally characterized by small manufacturing scale, serious contamination, low levels in energy consumption and technical equipment and insufficient capability of technical innovations. So, how to make full and reasonable use of the magnesium slag, particularly refined magnesium slag becomes one major problem that restricts the magnesium industrial development in our country. In view of the urgent demand for energy, resource and environment protections, researches on recycling of industrial wastes have become one of strategic targets for sustainable development and also one of the study focuses for industry experts and scholars.

Currently, researches on recycling of magnesium slag are mainly directed to the use of the refined magnesium slag as ingredient for firing cement clinker and as active admixture of cement. However, the refined magnesium slag among the magnesium slag is directly discarded as waste which not only occupies a lot of land resources, thereby causing terrible wastage of resources, but also further deteriorates environment contamination. The refined magnesium slag is an industrial waste with potential activity, and the refined magnesium slag has relative complex components, usually including magnesium particles, MgO, Fe₂O₃, MgCl₂, KCl and NaCl, etc., which complex components result in huge difficulty in recycling the magnesium slag in batch and high cost, so that a reasonable and efficient method for recycling a magnesium slag in batch has been provided not yet. A Chinese patent CN1140765 has disclosed a treatment method for refined magnesium slag, in which larger magnesium metal particles in the magnesium slag are firstly screened out, or processes such as crushing, digesting and filtering are carried out directly so as to separate the chlorides in the magnesium slag from water-insoluble substances, from which water-insoluble substances magnesium particles are obtained by sifting. The separated water-insoluble magnesium particles are again added into a digesting solution or can be dissolved in a hydrochloric acid and filtered, and the produced filtrate is evaporated and concentrated to obtain a primary product for the No. 2 flux used in magnesium smelting. However, all the products obtained by this method are to be subject to evaporating and concentrating processes with a higher energy consumption, with a produced primary product for No. 2 flux of low value, thereby making no benefit to industrialization. A Chinese patent CN101704010 has disclosed a method for preparing coarse magnesium particle, flux and magnesium brick from the refined magnesium slag in steps. Specifically, as raw material for manufacturing magnesium powder or magnesium ingot, coarse magnesium particles can be obtained by crushing, pulverization and air-separation from collected refined magnesium slag discarded in magnesium metal and magnesium alloy plants. The residues are dissolved and filtered, and the mother solution is evaporated, concentrated, dehydrated, melted, cooled and crushed so as to obtain a finished dehydrated carnallite (for producing magnesium metal and magnesium alloy flux). Further, the waste magnesium slag that is filtered out can be formed into a highly refractory magnesium brick which is chemically bonded and sintered. However, this process is complex with a higher cost and product of low value, thereby making no benefit to industrialization. A Chinese patent application CN102424916 has disclosed a method for preparing low sodium carnallite, sodium chloride and magnesium chloride from a refined magnesium slag, in which magnesium particles are separated from the magnesium slag by methods like crushing and sifting. Then, soluble chlorides are separated from water-insoluble substances by means of dissolving and filtering, and then the sodium chloride and the carnallite are obtained in sequence from the filtrate by means of processes such as ion ratio adjustment, evaporating and concentrating. The filter residue is dissolved in a hydrochloric acid and filtered, and then the sodium chloride, the carnallite and magnesium chloride are obtained in sequence from the filtrate by means of processes such as ion ratio adjustment, evaporating and concentrating. However, this process is complex with a high energy consumption and cost, because all the obtained products have to be subject to processes such as evaporating and concentrating. Further, the sodium chloride and magnesium chloride obtained by this method have a low magnesium purity, resulting in low value and disadvantages to industrialization.

Therefore, there is a need in researching and developing a reasonable and efficient method for recycling a magnesium slag, with which great environmental benefit and economic benefit can be provided.

### SUMMARY

In view of the above mentioned problems in prior art, one object of this invention is to provide a treatment method for a magnesium slag, with which a high recycling rate of the magnesium slag and a higher added value of recycled products are obtained, and the contamination to the environment is greatly reduced with a greater environment friendlessness, because three kinds of wastes can be efficiently recycled so as to provide excellent economic benefits and environmental benefits.

Following solutions according to this invention are adopted for achieving the above object of the invention:

A treatment method for a magnesium slag comprises particularly the following steps:

Step a, producing magnesium particles and a crude solution of magnesium slag by digesting and sifting a magnesium slag;

Step b, filtering the crude solution of magnesium slag sifted in Step a, so that mixed chlorides are obtained after a moisture in a filtrate is removed;

Step c, obtaining a high purity magnesium oxide, whose purity is not less than 95% or 98%, by dissolving a filter residue obtained in Step b via an ammonium sulfate method and a magnesium precipitation reaction as well as post-treatment.

Preferably, the magnesium slag is further pre-treated by crushing before digesting in Step a.

Preferably, the remove of moisture from the filtrate in Step b is effected by evaporating, concentrating, filtering, drying or any other moisture removing method in the prior art such as vacuum drying method, depending on the production conditions in applications of the present invention.

Preferably, the ammonium sulfate method in Step c uses a solution (NH₄)₂SO₄.

Preferably, the post-treatment in Step c comprises, but not limited to, filtering and calcining, and preferably filtering, cleaning and calcining the filter residue obtained from the magnesium precipitation reaction.

Preferably, the above mentioned magnesium slag is refined magnesium slag, preferable a waste produced during refining of magnesium, magnesium alloy or waste materials thereof.

Further preferably, Step a specifically comprises the following steps:

Step a1: the magnesium slag is pre-treated by crushing to a particle size of less than 2 meshes, so as to reduce the digestion time and magnesium particle lost;

Step a2: digesting the crushed magnesium slag in water (curing), so that the oxides in the magnesium slag are further dispersed into smaller particles to separate fully from the magnesium particles, while dissolving the chlorides in the magnesium slag in water;

Step a3: sifting the digested magnesium slag solution to obtain solid magnesium metal and the crude solution of magnesium slag.

Further preferably, Step a1 is specifically operated as crushing the refined magnesium slag via a crusher, wherein a screen plate in the crusher has a aperture size of 2 to 10 meshes, which shall be limited to a maximum particle size among the refined magnesium slag particles to be treated and can be adjusted in view of actual magnesium slag conditions.

Further preferably, Step a2 is specifically operated as digesting the crushed magnesium slag in water, with a mass ratio of the magnesium slag to water during digestion of 1:2 to 1:3, and a digestion time of 0.5 to 3 hours, preferably 2 hours.

Further preferably, Step a3 is specifically operated as sifting the magnesium slag solution which is fully digested so as to separate magnesium metal particles and the crude solution of magnesium slag, wherein a sifter used for sifting has a aperture size of 10 to 20 meshes, so that more than 90% of magnesium metal particles cannot pass through said sifter in view of such requirement to sifter aperture size.

Further preferably, Step b specifically comprises the following steps:

Step b1: filtering the sifted crude solution of magnesium slag;

Step b2: evaporating a filtrate obtained from Step b1;

Step b3: further concentrating the filtrate obtained from Step b2;

Step b4: further filtering a concentrated solution obtained from Step b3, with the filtrate again going through Step b2 and processes thereafter and the filter residue being remained for use;

Step b5: drying the filter residue obtained from Step b4 to obtain solid mixed chlorides.

Further preferably, Step b1 is specifically operated as filtering the sifted crude solution of magnesium slag, with a filter aperture size of less than 500 meshes.

Further preferably, Step b4 is specifically operated as filtering the concentrated solution with a filter aperture size of less than 500 meshes.

Further preferably, the filtrate evaporating, concentrating and drying in Steps b2 to b5 are carried out with a crystallizer in combination with supporting filtering device and drying device.

Further preferably, Step c specifically comprises the following steps:

Step c1: dissolving the filter residue obtained from Step b1 via the ammonium sulfate method to obtain a magnesium ion solution;

Step c2: filtering the solution obtained from Step c1;

Step c3: processing the filtrate obtained from Step c2 in a magnesium precipitation reaction;

Step c4: filter the magnesium precipitation reaction solution obtained from Step c3;

Step c5: cleaning the filter residue in Step c4;

Step c6: calcining the filter residue obtained from Step c5 to obtain the magnesium oxide.

Further preferably, Step c1 is specifically operated as dissolving the filter residue obtained by the filtering in Step c1 in a solution of (NH₄)₂SO₄, with a preferable concentration of the solution of (NH₄)₂SO₄ of 1.0 to 1.2 mol/L and an amount of dissolved filter residue in the solution of (NH₄)₂SO₄ of 50 to 60 g/L. As a further preferable option, the above mentioned dissolving process further comprises heating the solution to boiling by other heating devices and staying for 5 to 10 minutes. The heating is conducted for evaporating a portion of ammonia gas in the solution so as to bring the dissolving reaction in progress towards the right side, facilitating dissolution of the magnesium oxide.

Further preferably, Step c2 is specifically operated as filtering the solution of Step c1, with a filter aperture size of less than 500 meshes. In this case, the filter residue after filtering comprises substantially SiO₂, Al(OH)₃, Fe(OH)₃, CaSO₄ and small amount of MgO, etc., with a total amount generally less than 10% of a total amount of the magnesium slag. The above mentioned solid substances are stabile relatively, less contaminative to the environment and thus can be discarded or can be used as roadbed fillers in road construction.

Further preferably, Step c3 is specifically operated as using ammonium hydroxide and ammonium bicarbonate as magnesium precipitator for precipitating Mg²⁺ in a solution obtained from Step c2, wherein the ammonium hydroxide has a concentration of preferably 15 to 25%, and Mg²⁺, NH₃.H₂O and NH₄HCO₃ have a mole ratio of 1:1:1-1.2.

As a further preferable option, a solid ammonium bicarbonate is added in the magnesium precipitation reaction solution preferably in a small amount but many times, with each adding amount of 2 to 5 g/L.

As a further preferable option, an ammonia gas generated in Step cl is collected as magnesium precipitator in Step c3, and the ammonia gas can be dissolved in water before being added into the reaction solution, or can be directly introduced into the reaction solution, or a steam in Step a and the ammonia gas are here collected to form ammonia hydroxide as magnesium precipitator in Step c3.

Further preferably, Step c4 is specifically operated as filtering the reacted solution to collect the filtrate and filter residue respectively, after the magnesium precipitation reaction solution is fully reacted and precipitated. A concentration of Mg²⁺ in the reaction solution can be detected by methods in prior art so as to confirm the ending of the reaction.

As a preferable option, the filtrate in Step c4 has a pH value of 4.5 to 6.0 by adjustment via H₂SO₄, and (NH₄)₂SO₄ is further added for bringing the NH₄⁺ concentration in the filtrate up to 1.0-1.2 mol/L, so that it is possible to making best use of the solution for dissolving the magnesium oxide in the magnesium slag in Step c1 using the ammonium sulfate method.

Further preferably, Step c5 is specifically operated as cleaning fully with pure water the filter residue obtained from Step c4 so as to bring an ion Cl⁻ concentration in the clean solution to less than 0.001 mol/L to remove soluble salts included in the precipitants for increasing the resultant purity of the magnesium oxide.

Further preferably, Step c6 is specifically operated as calcining the cleaned precipitants after preliminary drying, with a calcining temperature of between 800 to 900° C. and a duration of between 1.5 to 2 hours, so as to obtain the magnesium oxide.

The present invention has advantages over the prior art in that the magnesium oxide in the magnesium slag can be dissolved using the ammonium sulfate method, particularly using (NH₄)₂SO₄ as solution for substantially decreasing an impurity ion content entered in the magnesium precipitation reaction, and the impurity is further removed by filtering to obtain a Mg²⁺ solution with less impurity as basis for producing a high purity magnesium oxide with a resultant purity of produced magnesium oxide of more than 98%, which meets the requirement of the high purity of magnesium oxide. The specific reaction principle is set forth as follows:

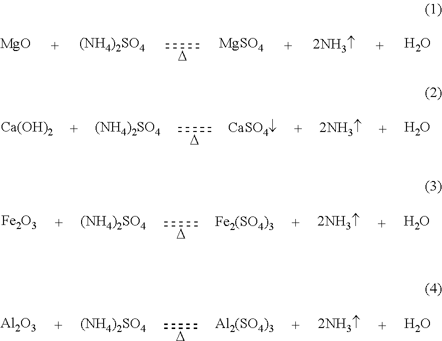

wherein Fe³⁺, Al³⁺ and Mg²⁺ generated after full precipitation have a pH value of 4.1, 5.2 or 12.4 respectively, so that Fe³⁺ and Al³⁺ have been substantially fully precipitated in the above mentioned solution with a pH value of between 5 to 6, with Fe(OH)₃ and Al(OH)₃ generated through reactions specifically as follows:

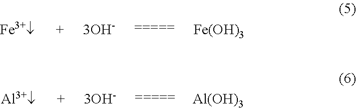

The above solution is filtered, so that an Mg²⁺ solution with less impurity metal ions can be obtained.

It is worth mentioning that a further advantage of this invention is presented in that the precipitated magnesium and filtered solution can be reused for the dissolving process with the (NH₄)₂SO₄ solution after adjustment of the pH value and addition of suitable amount of (NH₄)₂SO₄, resulting in substantial reduction of consumption of raw materials and production cost on one hand, and reduction of waste water discharge to a maximum extent. In the meantime, the ammonia gas generated in the dissolving process of the magnesium oxide can also be used in the magnesium precipitation process to reduce the waste gas discharge. In this case, three kinds of wastes in the recycling method according to this invention can be used to their full extent to meet the required energy saving and emission reduction, environment friendliness, etc..

In addition, the utilization of the magnesium slag by means of the method according to this invention can be raised to 90%, with a high recycling rate, while a discharge of solid wastes can be reduced substantially which are less contaminative to the environment, so that the contamination to the environment is greatly reduced and the required energy saving and emission reduction are also achieved, thereby providing a particularly broad prospect of its usage.

### DESCRIPTION OF DRAWINGS

FIG. 1 is a schematic flow chart of a treatment method for a magnesium slag according to this invention.

### SPECIFIC EMBODIMENTS

A detailed and complete description of this invention will be given below, with reference to some embodiments thereof.

### Embodiment 1

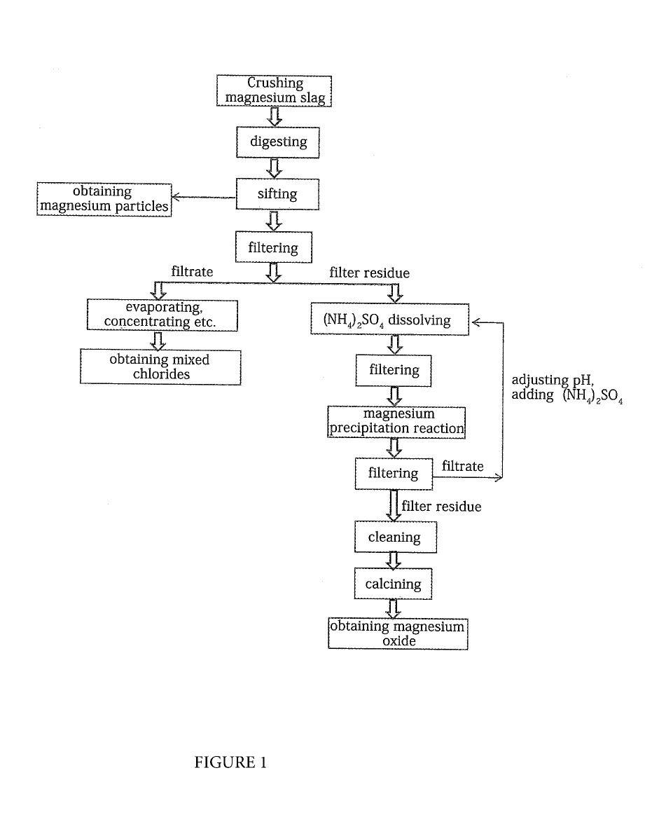

In this embodiment, a magnesium slag generated as casted scraps of refined magnesium and magnesium alloy by Hunan s.r.m Technology Co., Ltd. as raw materials in a recycling method of this invention, wherein the magnesium slag has a lower content of magnesium particles. The specific procedure is shown in FIG. 1 and particularly comprises:

(1) crushing: a refined magnesium slag with a particle diameter of 1.0 to 5.0 mm is crushed by means of a crusher with a sifter aperture size of 3 meshes;

(2) digesting (curing): the crushed magnesium slag is digested via water, with a mass ratio of the magnesium slag to water during digestion of 1:3 and a digestion time of 2 hours;

(3) sifting: a vibrosieve with 16 meshes is used to screen the above mixed solution to separate magnesium particles therefrom;

(4) filtering: the mixed solution after separating magnesium particles is filtered using a filter press with a filter cloth of 500 meshes;

(5) removing moisture from a filtrate: a crystallizer and supporting filtering device and drying device are used to conduct processes such as evaporating, concentrating, filtering or drying with respect the filtrate generated by filtering so as to obtain mixed chlorides;

(6) dissolving via ammonium sulfate method: a filter residue generated by filtering in Step (4) is dissolved in ammonium sulfate solution, with a concentration of (NH4)₂SO₄ of 1.2 mol/L and a amount of dissolved filter residue in the (NH4)₂SO₄ solution of 60 g/L. An electrical heating tube is used during dissolution for heating the solution to boiling and staying for 5 min, wherein an ammonia gas generated in the reaction process is introduced into pure water to form the ammonium hydroxide for further magnesium precipitation reaction;

(7) filtering: the above mentioned solution is filtered by means of a filter press with a filter cloth of 500 meshes, wherein the filter residue generated by filtering can be used as roadbed filler in road construction or discarded;

(8) magnesium precipitation reaction: ammonium hydroxide and ammonium bicarbonate can be used as magnesium precipitator, wherein the ammonium hydroxide has a concentration of 20% and can be obtained by mixing a concentrated ammonium hydroxide with the ammonium hydroxide generated in Step (6) in a certain ratio, while the ammonium bicarbonate is added in a solid form with each adding amount of 2 to 5 g/L, up to a predetermined amount, so as to ensure that Mg²⁺, NH₃.H₂O and NH₄HCO₃ have a mole ratio of 1:1:1;

(9) filtering: the above mentioned solution is filtered by means of a filter press with a filter cloth of 500 meshes, and the generated filtrate has a pH value of about 5.0 by adjustment via H₂SO₄, wherein (NH₄)₂SO₄ is added to bring the NH⁴⁺ concentration in the solution to 1.2 mol/L, which solution can be circulated for dissolving the magnesium oxide in the magnesium slag in Step (6) via ammonium sulfate method;

(10) cleaning: the precipitants generated by filtering are cleaned with pure water, so that the concentration of Cl⁻ contained in the clean solution is less than 0.001 mol/L;

(11) calcining: the cleaned precipitants are calcined at a temperature of 810° C., with a calcining duration of 2.0, so as to obtain the magnesium oxide.

100 Kg of refined magnesium slags are recycled by the above mentioned method, with 5.2 Kg of recycled magnesium particles, 40.2 Kg of mixed chlorides, 42.8 Kg of magnesium oxides and 7.4 Kg of filter residues in Step (7) being obtained, wherein a recycling rate or utilization of the magnesium slag is 88.2% and a purity of the magnesium oxide reaches up to 98.6%, thereby meeting the requirement of high purity magnesium oxide.

### Embodiment 2

This embodiment is differentiated from Embodiment 1 only in that a magnesium slag generated as waste die-casted parts of refined magnesium and magnesium alloy by Hunan s.r.m Technology Co., Ltd. is used as the magnesium slag, wherein magnesium metal particles in said magnesium slag have a diameter of 1.0 to 7.0 mm, and further, the refined magnesium slag is crushed by means of a crusher with a sifter aperture size of 2 meshed in Step (1).

100 Kg of refined magnesium slags are recycled, with 7.6 Kg of recycled magnesium particles, 45.1 Kg of mixed chlorides, 36.4 Kg of magnesium oxides and 9.2 Kg of filter residues in Step (6) being obtained, wherein a recycling rate or utilization of the magnesium slag is 89.1% and a purity of the magnesium oxide reaches up to 98.1%, thereby meeting the requirement of high purity magnesium oxide.

### Embodiment 3

This embodiment is differentiated from Embodiment 1 only in that the (NH₄)₂SO₄ solution used in Step (6) via the ammonium sulfate method is generated by adjusting the pH value of the filtrate obtained in Step (9) in Embodiment 2 using H₂SO₄ and adding (NH₄)₂SO₄, wherein the solution has a pH value of 5.0 and a NH₄⁺ concentration of 1.2 mol/L. The filter residue dissolved in the (NH₄)₂SO₄ solution amounts to 60 g/L.

100 Kg of refined magnesium slags are recycled by the above mentioned method, with 7.8 Kg of recycled magnesium particles, 44.9 Kg of mixed chlorides, 37.0 Kg of magnesium oxides and 9.4 Kg of filter residues in Step (6) being obtained, wherein a recycling rate or utilization of the magnesium slag is 89.7% and a purity of the magnesium oxide reaches up to 98.2%, thereby meeting the requirement of high purity magnesium oxide.

### Embodiment 4

This embodiment is differentiated from Embodiment 1 only in that: Step (2) digesting (curing): the crushed magnesium slag is digested via water, with a mass ratio of the magnesium slag to water during digestion of 1:2 and a digestion time of 2 hours;

Step (3) sifting: the above mentioned mixed solution is sifted by means of a vibrosieve having 10 meshes to separate magnesium particles therefrom;

Step (6) dissolving via the ammonium sulfate method: (NH₄)₂SO₄ has a concentration of 1.0 mol/L, and the filter residue dissolved in the (NH₄)₂SO₄ solution amounts to 50 g/L. An electrical heating tube is used in the dissolving process for heating the solution to boiling and staying for 10 min;

Step (8) the magnesium precipitation reaction: the ammonium hydroxide has a concentration of 15%, and Mg²⁺, NH₃.H₂O and NH₄HCO₃ have a mole ratio of 1:1:2;

Step (9) filtering: the pH value of the filtrate is adjusted to about 6.0 using H₂SO₄, and (NH₄)₂SO₄ is added to bring the NH⁴⁺ concentration in the solution to 1.0 mol/L;

Step (11) calcining: the cleaned precipitants is calcined at a temperature of 900° C. with a calcining time of 1.5 hours, so as to obtain the magnesium oxide.

100 Kg of refined magnesium slags are recycled, with 4.0 Kg of recycled magnesium particles, 41.0 Kg of mixed chlorides, 43.5 Kg of magnesium oxides and 7.6 Kg of filter residues in Step (6) being obtained, wherein a recycling rate or utilization of the magnesium slag is 88.5% and a purity of the magnesium oxide reaches up to 98.3%, thereby meeting the requirement of high purity magnesium oxide.

### Embodiment 5

This embodiment is differentiated from Embodiment 1 only in that:

Step (3) sifting: the above mentioned mixed solution is sifted by means of a vibrosieve having 20 meshes to separate magnesium particles therefrom;

Step (6) dissolving via the ammonium sulfate method: (NH₄)₂SO₄ has a concentration of 1.1 mol/L, and the filter residue dissolved in the (NH₄)₂SO₄ solution amounts to 55 g/L. An electrical heating tube is used in the dissolving process for heating the solution to boiling and staying for 8 min;

Step (8) the magnesium precipitation reaction: the ammonium hydroxide has a concentration of 25%;

Step (9) filtering: the pH value of the filtrate is adjusted to about 4.5 using H₂SO₄, and (NH₄)₂SO₄ is added to bring the NH⁴⁺ concentration in the solution to 1.1 mol/L;

Step (11) calcining: the cleaned precipitants is calcined at a temperature of 800° C. with a calcining time of 2.0 hours, so as to obtain the magnesium oxide.

100 Kg of refined magnesium slags are recycled, with 5.9 Kg of recycled magnesium particles, 40.9 Kg of mixed chlorides, 41.5 Kg of magnesium oxides and 7.3 Kg of filter residues in Step (6) being obtained, wherein a recycling rate or utilization of the magnesium slag is 88.3% and a purity of the magnesium oxide reaches up to 98.5%, thereby meeting the requirement of high purity magnesium oxide.

Finally, it is to be noted here that all the above embodiments are only provided for further detailed description of the technical solution according to this invention, without being interpreted as limiting to the protection scope of this invention, so that all the non-essential changes and modifications a skilled person in the art can make to the above disclosure of this invention shall fall within the protection scope of this invention.

What is claimed is:

1. An environmentally friendly treatment method for a refined magnesium slag, characterized in that it comprises the following steps:
Step a, producing magnesium particles and a crude solution of magnesium slag by digesting and sifting a magnesium slag;
Step b, filtering the crude solution of magnesium slag sifted in Step a, so that mixed chlorides are obtained after a moisture in a filtrate is removed;
Step c, obtaining a magnesium oxide by dissolving a filter residue obtained in Step b via an ammonium sulfate method and a magnesium precipitation reaction as well as post-treatment;
the magnesium oxide is a high purity magnesium oxide with a purity not less than 95%.

2. The environmentally friendly treatment method for a refined magnesium slag according to claim 1, characterized in that a solution of (NH₄)₂SO₄ is used in the ammonium sulfate method of Step c.

3. The environmentally friendly treatment method for a refined magnesium slag according to claim 1, characterized in that the post-treatment in Step c comprises, but not limited to, filtering and calcining solids obtained from the magnesium precipitation reaction.

4. The environmentally friendly treatment method for a refined magnesium slag according to claim 1, characterized in that Step a comprises the following steps:
Step a1: the magnesium slag is pre-treated by crushing to a particle size of less than 2 meshes;
Step a2: digesting the crushed magnesium slag;
Step a3: sifting the digested magnesium slag solution to obtain a solid magnesium metal and the crude solution of magnesium slag.

5. The environmentally friendly treatment method for a refined magnesium slag according to claim 1, characterized in that Step b comprises the following steps:
Step b1: filtering the sifted crude solution of magnesium slag;
Step b2: evaporating a filtrate obtained from Step b1;
Step b3: further concentrating the filtrate obtained from Step b2;
Step b4: further filtering a concentrated solution obtained from Step b3, with the filtrate again going through Step b2 and processes thereafter, and the filter residue being remained for use;
Step b5: drying the filter residue obtained from Step b4 to obtain solid mixed chlorides.

6. The environmentally friendly treatment method for a refined magnesium slag according to claim 1, characterized in that Step c comprises specifically the following steps:
Step c1: dissolving the filter residue obtained from Step b1 by the ammonium sulfate method to obtain a magnesium ion solution;
Step c2: filtering the solution obtained from Step c1;
Step c3: processing the filtrate obtained from Step c2 in a magnesium precipitation reaction;
Step c4: filtering a magnesium precipitation reaction solution obtained from Step c3;
Step c5: cleaning the filter residue obtained from Step c4;
Step c6: calcining the filter residue obtained from Step c5 to obtain the magnesium oxide.

7. The environmentally friendly treatment method for a refined magnesium slag according to claim 6, characterized in that Step c1 is specifically operated as dissolving the filter residue obtained by filtering in Step c1 via the solution of (NH₄)₂SO₄.

8. The environmentally friendly treatment method for a refined magnesium slag according to claim 7, characterized in that (NH₄)₂SO₄ has a concentration of 1.0 to 1.2 mol/L, and the filter residue dissolved in the solution of (NH₄)₂SO₄ amounts to 50 to 60 g/L.

9. The environmentally friendly treatment method for a refined magnesium slag according to claim 6, characterized in that the dissolving process in Step c1 further comprises heating the solution to boiling and staying for 5 to 10 minutes.

10. The environmentally friendly treatment method for a refined magnesium slag according to claim 6, characterized in that Step c3 is specifically operated as using ammonium hydroxide and ammoniurn bicarbonate as magnesium precipitator.

11. The environmentally friendly treatment method for a refined magnesium slag according to claim 10, characterized in that the ammonia has a concentration of 15 to 25%.

12. The environmentally friendly treatment method for a refined magnesium slag according to claim 10, characterized in that Mg²⁺, NH₃.H₂O and NH₄HCO₃ have a mole ratio of 1:1:(1-1.2).

13. The environmentally friendly treatment method for a refined magnesium slag according to claim 10, characterized in that a solid ammonium bicarbonate is added into the magnesium precipitation reaction solution; the ammonium bicarbonate is added into the reaction solution in a small amount but many times, with each adding amount of 2 to 5g/L.

14. The environmentally friendly treatment method for a refined magnesium slag according to claim 6, characterized in that an ammonia gas generated in Step c1 is collected as magnesium precipitator in Step c3.

15. The environmentally friendly treatment method for a refined magnesium slag according to claim 14, characterized in that the collected ammonia gas is dissolved in water, before being added into the reaction solution as magnesium precipitator in Step c3; or the ammonia gas is introduced into the reaction solution as magnesium precipitator in Step c3.

16. The environmentally friendly treatment method for a refined magnesium slag according to claim 14, characterized in that a steam in Step a and the ammonia gas are collected to form an ammonia as magnesium precipitator in Step c3.

17. The environmentally friendly treatment method for a refined magnesium slag according to claim 6, characterized in that Step c4 is specifically operated as filtering the reacted solution to collect the filtrate and filter residue respectively, after the magnesium precipitation reaction solution is fully reacted and precipitated.

18. The environmentally friendly treatment method for a refined magnesium slag according to claim 17, characterized in that the filtrate in Step c4 has a pH value of 4.5 to 6.0 by adjustment via H₂SO₄, and (NH₄)₂SO₄ is further added for bringing the NH₄⁺ concentration in the filtrate up to 1.0-1.2 mol/L, so as to use the solution obtained thereby as a dissolution solution to the magnesium oxide in the magnesium slag in Step c1 using the ammonium sulfate method.

19. The environmentally friendly treatment method for a refined magnesium slag according to claim 6, characterized in that Step c5 is specifically operated as cleaning fully with pure water the filter residue obtained from Step c4 so as to bring an ion C1 concentration in the clean solution to less than 0.001 mol/L.

20. The environmentally friendly treatment method for a refined magnesium slag according to claim 19, characterized in that Step c6 is specifically operated as calcining the cleaned precipitants after preliminary drying; the calcining process has a temperature of between 800 to 900° C. and a duration of between 1.5 to 2 hours.
